(19) United States
(12) Patent Application Publication
(10) Pub. No.: US 2008/0036842 A1
(43) Pub. Date: Feb. 14, 2008

(54) Electronic printing press

(76) Inventor: Peter C. Salmon, Mountain View, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/502,223

(22) Filed: Aug. 9, 2006

(51) Int. Cl. B41J 2/385

(52) U.S. Cl. 347/158

(57) ABSTRACT

An electronic printer comprising a source of charged toner particles, a writing head capable of imaging individual toner particles, means to transfer the toner image to a print substrate, and a fuser. The writing head employs toner conveyors driven by voltage traveling waves. Imaging is achieved using a diverter electrode in each toner conveyor, and diverted toner is returned to the toner source. High speed is achieved using a plurality of independent toner conveyors that operate in parallel. A printing press capable of printing variable images at 200 feet per minute with a print width of 48 inches and a print resolution of 2,400 dots per inch is described.

### FIELD OF THE INVENTION

This invention relates to printers and more particularly to an electronic method of variable printing at high resolution and high speed.

### DESCRIPTION OF THE RELATED ART

The fastest and highest quality printers or printing presses of today utilize offset printing or photogravure methods. With photogravure, an imaging drum is photolithographically patterned. With offset printing, image data is typically patterned on a plate. Using either method, the patterned surface is inked with a printing paste, and the paste image is transferred to a print substrate at high speed, in a repeating cycle. Thereby, multiple copies of the image data are created on the print substrate or medium. The print medium may be in the form of a web such as a continuous roll of paper, with the printed web being subsequently converted into printed sheets. The print substrate or medium can also be in sheet form. Photogravure printers can operate at web speeds of several hundred feet per minute, with typical print resolutions of 2,400 dots per inch. Their image quality is currently the best available among printers of all types. However, economical run lengths are typically around ten thousand printed pages because of substantial setup procedures and “make ready” costs for each printing run.

Modern commerce utilizes imagery in advertisements and brochures that often require up-to-date information. The information can change daily or even hourly. Thus a new type of printing has emerged, called “variable printing”, or “printing on demand”. Variable printers support short run lengths, typically a few hundred pages. They generally employ electronic printing methods, without requiring permanently patterned plates or drums. One such electronic method is the laser printing method, wherein a latent toner image is formed on a charged photoconductive drum by modulating light from a scanning laser beam. Where the surface of the photoconductive drum is illuminated by the spot of the laser beam, it is discharged. The resulting latent image is developed by flowing charged toner over the drum, to form a toner image. The toner image is typically transferred to a roll or belt and from there to a print substrate where it is fused to form a permanent image. For high speed printers, the laser printing process is limited by the serial nature of the laser scan; each laser beam can image only one pixel at a time. One pixel corresponds to one spot or one dot on the printed page.

Chemical toners or polymerized toners are created by growing toner particles out of a liquid bath. The prior method of toner manufacture involved grinding of plastic material, and sieving to classify particle size. This produced “attrited toner” which was characterized by irregularly shaped particles. By contrast, chemical toners produce particles with uniform size and shape. Of the available shapes, spherical particles are the simplest and easiest to produce. Although more primary colors are sometimes used, cyan, magenta, yellow, and black (CMYK) form a typical set of primary colors. A full gamut of printed colors can be created by overlaying measured amounts of the primary colors. Translucent toner particles typically provide the best color quality in overlaid images of this type.

Flat panel displays (FPDs) are currently being manufactured on glass panels as large as 2160 mm by 2400 mm, with feature sizes (line width and space) smaller than 1 μm. By comparison, the writing head of the preferred embodiment of the current invention requires a feature size of around 1.8 μm and a width dimension of around 50 inches or 1270 mm.

The following related patents are hereby incorporated by reference in their entirety for their teachings:

U.S. Pat. No. 5,153,617 to Peter C. Salmon, issued Oct. 6, 1992, for “Digitally Controlled Method and Apparatus for Delivering Toners to Substrates”.

U.S. Pat. No. 5,400,062 to Peter C. Salmon, issued Mar. 21, 1995, for “Electrostatic Printing Apparatus and Method”.

U.S. Pat. No. 6,309,049 to Peter C. Salmon, issued Oct. 30, 2001, for “Printing Apparatus and Method for Imaging Charged Toner Particles Using Direct Writing Methods”.

In particular, these patents teach the use of particle conveyors employing voltage traveling waves (617); digitally controlled toner conveyors (062); and polymerized toners and diverter electrodes (049).

### SUMMARY OF THE INVENTION

An electronic printing method is described for printing variable images at rates of several hundred feet per minute, with a print width of 48 inches and a print resolution of 2,400 dots per inch. A dry toner is employed and each particle is electrostatically charged. The imaging method employs voltage traveling waves applied to toner conveyors arrayed in columns, each column imaging toner for delivery to one pixel on the printed page. The toner is imaged using diverter electrodes, and each toner particle is individually controlled and imaged in the preferred embodiment. For color printing, a separate print engine is provided for each primary color, and the print engines are arranged in series. Thus, the primary colors are super-imposed to create the hues of the final image.

### BRIEF DESCRIPTION OF THE DRAWINGS

The accompanying drawings, which are somewhat schematic in some instances and are incorporated in and form a part of this specification, illustrate a primary embodiment of the invention and, together with the description, serve to explain the principles of the invention.

FIG. 1 is a schematic cross-sectional view of a print engine of the current invention.

FIG. 2 is a schematic top view of an expanded region of a writing head of the current invention.

FIG. 3 is a cross-sectional view of a toner particle traveling on a writing head.

FIG. 4 is a graph of voltage versus time for writing head control signals.

FIG. 5 is a schematic top view of a portion of a writing head showing attached integrated circuit chips and routing of the control signals.

FIG. 6 is a schematic side view of a high speed printing press of the current invention.

FIG. 7 is flow chart describing the print method of the current invention.

### DETAILED DESCRIPTION OF THE PREFERRED EMBODIMENTS

Various embodiments of the present invention are described hereinafter with reference to the figures. It should also be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in any other embodiments. For instance, the preferred embodiment describes a high-end printer with resolution of around 2,400 dpi. Lower resolution printers may have adequate quality for many applications and may be manufacturable at lower cost. Such lower resolution printers may use wider conveyors that image toner in groups of multiple particles rather than one particle at a time, yet the same imaging principles will apply. The imaging method of the current invention may also be employed with different supporting apparatus and methods. For example, toner particle charging may utilize a fluidized bed, as is known in the art; in this case toner charging will occur externally to the toner hopper. Different methods may be used for transferring the toner image or fusing it. For example a transfix process could be employed, or a radiant fuser. Additionally, other embodiments and applications will be apparent to those who are skilled in the art.

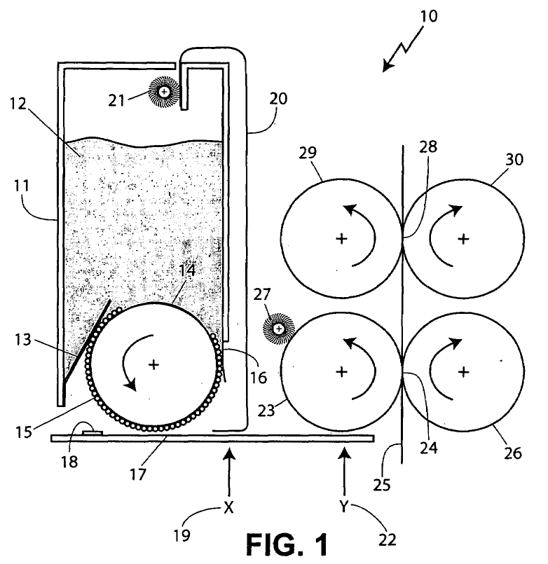

FIG. 1 shows print engine 10, used for printing a single color of toner. Print engine 10 includes a toner hopper 11 filled with a toner powder 12. The preferred toner is a “single component toner”, not requiring separate carrier particles. Toner particles preferably have a mean diameter of around 10 μm and are spherical in shape. A preferred charge to mass ratio for toner particles used herein is twenty micro-coulombs per gram. The particles are preferably produced by a polymerization process that results in a narrow size distribution; for example, at least 80% of the toner should have a diameter within 20% of the mean toner diameter. Such a controlled size distribution is required for the highest quality printed images at the preferred print resolution of 2,400 dots per inch (DPI). In the preferred embodiment, toner particles 12 are tribo-electrically charged using a metering plate 13 working against a donor roll 14 having a textured surface, as is known in the art. Metering plate 13 is preferably made from a thin sheet of stainless steel; it is flexible and is pressed against donor roll 14. Donor roll 14 is preferably at least 4 inches in diameter for high speed operation such as 200 feet per minute printing, to be further described. Donor roll 14 is preferably made from aluminum with a surface that has been textured by sand-blasting. A thin layer or monolayer 15 of charged toner particles is formed on the surface, as shown, using over-size particles for visualization. A flexible sheet 16 is provided at the back side of roller 14 as shown; a preferred material for flexible sheet 16 is polyester. Its function is to allow unused toner to circulate back inside hopper 11, and prevent spillage of toner 12 onto writing head 17. Writing head 17 is preferably fabricated on a flat glass substrate, and has a print width of 48 inches in the preferred embodiment. Writing head 17 preferably has attached integrated circuit (IC) chips 18, which provide control voltages for conveying and imaging the toner particles, to be further described. At location X 19, diverter electrodes are provided, to be further described. The diverter electrodes will eject from toner conveyors particles that are not needed in the toner image. The ejected particles are preferably returned to the toner hopper 11 using a return conveyor, 20. After entering the hopper, returned toner particles are brushed off of the return conveyor using rotating brush 21. Return conveyor 20 is built on a flexible substrate and follows a shaped path as shown. Preferably the writing head 17 and the return conveyor 20 both employ voltage traveling waves for conveying (transporting) the toner, to be further described. The toner image formed at location X 19 is conveyed to a pick-off point at location Y 22, where the imaged toner particles are transferred to a first transfer roll 23. The transferred toner image rotates on roll 23 to a first nip 24 which pinches the print substrate 25 between the first transfer roll 23 and a second transfer roll 26. Residual toner that remains on roll 23 after the transfer step is cleaned off using rotating brush 27. The toner image is transferred to print substrate 25 using pressure asserted in the first nip 24; some heating may also be applied at this step to soften the toner particles and improve the transfer. Subsequently the transferred toner image arrives at the second nip 28 formed between opposing fuser rolls 29 and 30 where it is permanently fused to the print substrate 25 using pressure and heat. If print engines 10 are arranged in series to form a multi-color printing system, the number of fuser roll pairs may vary from one to the number of print engines in the system. Rolls 23, 26, 29, and 30 are all preferably at least 4 inches in diameter to support a speed of print substrate 25 as high as 200 feet per minute. The rolls preferably have a working length that supports an image width of 48 inches. The preferred embodiment employs a web feed for the print substrate (print medium), although sheet formats may also be employed.

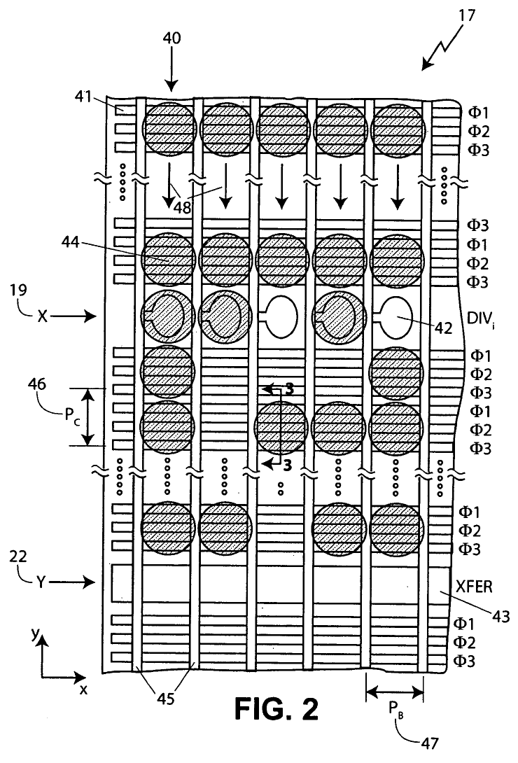

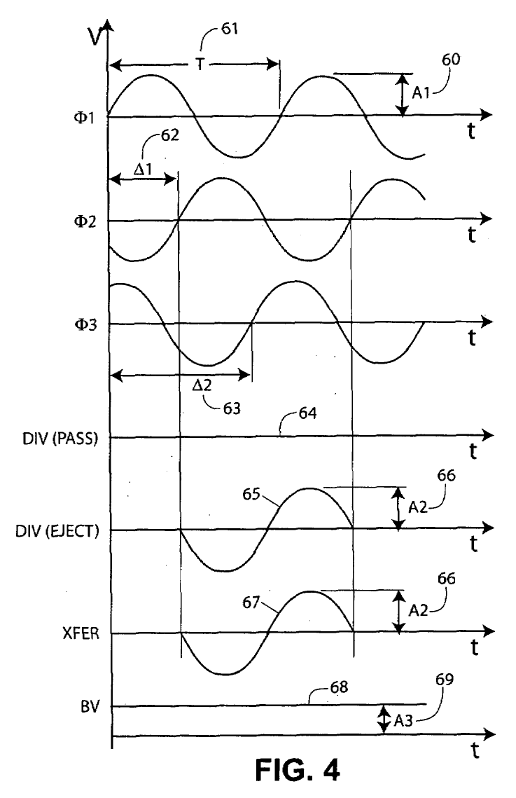

FIG. 2 shows an expanded region of writing head 17, illustrating toner conveyors such as 40. Conveyor 40 includes a linear array of conveyor electrodes such as 41. Conveyor electrodes are labeled Φ1, Φ2, Φ3, corresponding to phases of a voltage traveling wave, connected in repeating order as shown. The minimum number of phases that can be used is 3, but 4 phases have also been successfully used. Each toner conveyor 40 includes a diverter electrode 42 labeled “DIVᵢ” that is positioned at location X 19 in FIG. 1, and a transfer electrode 43 labeled “XFER” that is positioned at location Y 22 in FIG. 1. Each diverter electrode is individually controlled, where subscript “i” refers to the column number (conveyor number) of a particular diverter. Idealized toner particles such as 44 are shown. Real particles will be almost perfect spheroids, because of their method of manufacture. However, their size will vary slightly and their surfaces will typically include tiny particles of silica or similar material to improve flow properties, plus sub-micron particles of charge control agents (CCAs) that help to create uniform total charge and a uniform distribution of charge on the surface of the particles. Additionally, colorant is added to the toner particles in the form of pigments or dyes. Pigments are usually in the form of micro crystals, and dyes are typically distributed throughout the base polymer. Barrier electrodes 45 define the width of toner conveyor 40; they are connected to a fixed barrier voltage (BV) that helps to electrostatically confine particles to the conveyor without jumping between conveyors, to be further described. Three conveyor electrodes connected to Φ1, Φ2, Φ3, comprise a repeating segment of toner conveyor 40, including a full set of traveling wave voltages, to be further described. The pitch PC 46 of this set of three conveyor electrodes is 10.6 μm in the preferred embodiment, matching the 2,400 DPI print resolution. Similarly, the preferred pitch PB 47 of the barrier electrodes is 10.6 μm, again matching the preferred 2,400 DPI print resolution. Thus, the same print resolution is implemented in the x and y directions, referring to the transverse and longitudinal dimensions of the print substrate, respectively. A “pixel site” is an x-y address on the print medium, to which toner particles are directed to form a “picture element” of the printed image. The diverter electrode 42 is preferably shaped like a paddle, as shown; it preferably occupies one segment of its conveyor. Similarly, the transfer electrode 43 occupies one segment in the direction of toner travel (the longitudinal direction), and spans all of the conveyors in the transverse direction. The toner particles move on the conveyors as shown by arrows 48. At the top of the figure, prior to the diverter electrodes at location X, all conveyor electrodes are packed with particles, loaded from donor roll 14 of FIG. 1. As imaging occurs at location X, the particles are formed into a toner image. In a first preferred embodiment each toner conveyor is one particle wide, as defined by the spacing between the barrier electrodes 45. Acting on a particle centered in the space above it, each diverter will deliver either a particle or an absence of a particle to the next element in the printing chain; in this case the next element is the portion of the toner conveyor that is downstream of the diverter. A diverter in the PASS state will deliver a particle, and a diverter in the EJECT state will deliver the absence of a particle, as will be further discussed in reference to FIG. 4. The diverter electrodes operate in response to control signals generated by a print algorithm operating on print data. At the transfer electrode 43 at location Y, all particles remaining on the conveyor are ejected and thereby transferred to transfer roll 23 of FIG. 1. Toner conveyor 40 with diverter and transfer electrodes forms the basis of a single-particle-print engine that is individually controlled and creates an independent stream of imaged toner particles, one at a time, in response to control signals.

Since toner particles may cycle through the imaging process several times, depending on how many times they are ejected by a diverter electrode, the toner used in the current invention is preferably a “robust toner”. It will retain its physical size and shape as well as its charge characteristics, even as it is “worked” in the print engine. The preferred spherical shape of the toner supports this type of robustness. In addition, the writing head is preferably coated with a material that is tribo-electrically matched to the toner, to improve the tribo-electric environment for particles moving on the conveyors. Each contact of a charged particle with another particle or surface is a potential charging or discharging event. By coating the control surfaces (e.g., toner conveyors) with either the constituent materials of the toner particles or material equivalents having similar tribo-electric properties, the surfaces will behave like the surface of a toner particle, with respect to contact charging events. This is desirable because the toner particles are designed to collide and physically interact with each other without significantly charging or discharging one another. Neutral charging behavior of control surfaces should be optimized after a short period of operation, wherein the toner conveyors become coated with a distribution of flow control particles and charge control agents (additive particles) that came from interaction with the toner particles. The preferred steady state condition is that this distribution of additive particles remains approximately constant on the toner conveyor surfaces, resulting in an approximately constant distribution of charge on the toner particles as they move throughout the print engine. To implement this strategy, actual toner particles used in the print engine may be dissolved in toluene or other suitable solvent, creating a fluid that can be painted or sprayed on the conveyors to achieve a coating with the desired charging neutrality. Alternatively, the toner constituent materials or material equivalents, including one or more base polymers, flow control additives, charge control agents, and optionally the colorants, can be combined using a solvent to form a solution for coating the writing heads.

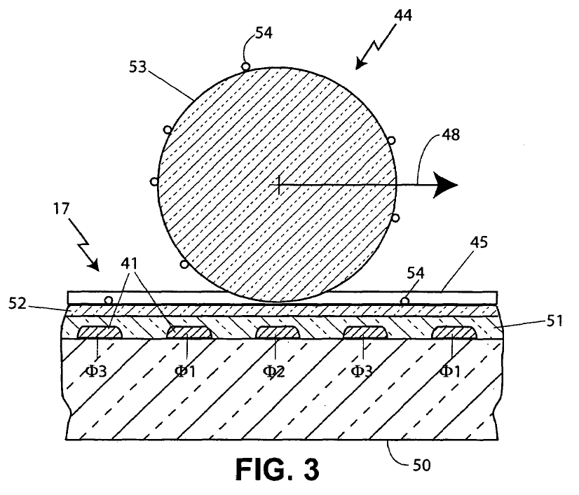

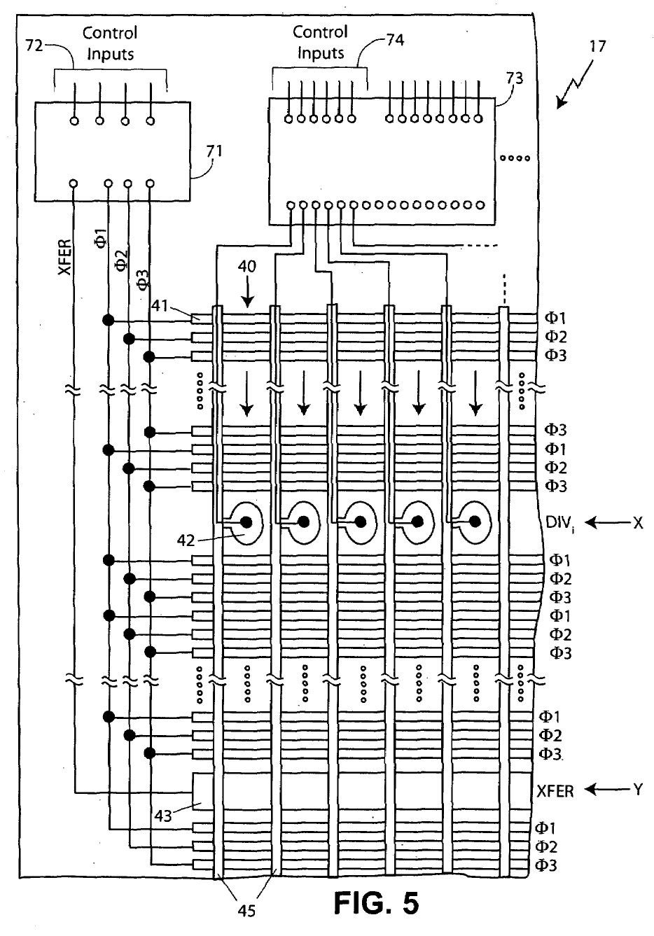

The resulting structure is shown in FIG. 3, corresponding to section 3-3 of FIG. 2. Writing head 17 is constructed on a glass substrate 50. A dielectric layer 51 is provided to insulate conveyor electrodes 41 from barrier electrodes 45 and traces carrying diverter control signals to be further described in reference to FIG. 5. The surface of the toner conveyor is coated with a special triboelectric coating 52. Toner particle 44 comprises a resin or polymer material 53 plus additive particles 54 which may be used for flow control or as charge control agents. Additive particles 54 typically take the form of fine (sub-micron) particles that adhere to the outer surface of the toner particle, and also deposit on the toner conveyor surface during operation as shown. In the preferred embodiment, the same tribo-electric coating 52 as is used on writing head 17 is used on the surface of return conveyor 20, in order to extend charging neutrality to that control surface (working surface) also.

FIG. 4 shows preferred waveforms for the phase voltages (traveling wave voltages) Φ1, Φ2, Φ3, and other control signals. Although square-shaped (digital) waveforms are also effective for transporting charged toner particles on toner conveyors of the current invention, sinusoidal waveforms are preferred because they move the toner more smoothly, and this means that fewer particles will stray from their intended path on the conveyors. In the preferred embodiment amplitude A1 60 is 40 volts (40V), and the period T 61 is 10 μsec. This corresponds to a frequency of 100 kHz, a wavelength of 10.6 μm, and a print speed of 200 feet per minute, or approximately one meter per second. The wavelength of 10.6 μm is the same as the length of a “repeating segment” of the toner conveyor, as described in reference to FIG. 2. Thus, the preferred print resolution is 2,400 DPI in both x and y directions, as previously discussed in reference to FIG. 2. Φ2 is delayed with respect to Φ1 by Δ1 62 equal to 120 degrees or π/3 radians. Φ3 is delayed with respect to Φ1 by Δ2 63 equal to 240 degrees or 2π/3 radians. When diverter electrode 42 of FIG. 2 is passing the toner without ejection (in the PASS state), the DIV(PASS) version of the waveform is employed. This is shown as ground potential 64 which allows the toner particles to pass over the diverter electrode without being ejected from the conveyor. When the diverter electrode is ejecting toner from its conveyor (in the EJECT state), the DIV(EJECT) version of the waveform 65 is employed, with preferred amplitude A2, 66. The DIV(EJECT) waveform 65 is preferably one cycle of the inverse of Φ2, with timing as shown. The preferred transfer waveform XFER 67 is the same as DIV(EJECT) 65 and is applied to transfer electrode 43 of FIG. 2. Particles have momentum as they travel on the toner conveyors, and experience has shown that each particle can easily pass across a gap where a set of Φ1, Φ2, and Φ3 electrodes is absent. Particle ejection occurs in the following manner. As it traverses the space above a diverter or transfer electrode, a toner particle to be ejected is influenced by an electric field opposite in direction to the field normally encountered at that location on the conveyor. This opposing field is asserted by the diverter or transfer electrode. It operates on the particle adjacent to the electrode (and only that particle), and ejects the particle from the conveyor. In the case of the diverter electrodes, ejected particles are collected by the return conveyor 20 of FIG. 1. In the case of the transfer electrode, ejected particles are collected by first transfer roll 23 of FIG. 1. The preferred amplitude A2 66 of the waveform applied to the diverter and transfer electrodes is 40V, the same as A1, although it can be varied to optimize the printing process for particular types of toner particles carrying particular charge distributions. The preferred embodiment employs positively charged toner particles, although negatively charged particles can equally well be used. For positive toner particles, barrier voltage BV 68 will have a positive DC value 69 such as +20V. This creates an electrostatic rail on each side (longitudinal edge) of a toner conveyor, confining each particle to move along its own intended conveyor without jumping to an adjacent conveyor. If such jumping occurred, it would introduce noise in the toner image. Higher values of BV will reduce toner jumping between conveyors, but make it more difficult to load toner onto the conveyors from donor roll 14 of FIG. 1.

FIG. 5 illustrates the electrical connections at the left end of writing head 17 from FIG. 1. Integrated circuit chip 71 accepts control inputs 72 from a print controller and provides driver circuits that feed control signals, Φ1, Φ2, Φ3, and XFER to the writing head, connected as shown schematically. Preferably high current drivers are provided on chip 71, and only one copy of the chip is required to drive the entire writing head, including 48-inch traces for each of Φ1, Φ2, Φ3 and XFER. Integrated circuit chip 73 also accepts control inputs 74 from the print controller and responds by driving a separate control signal to each diverter electrode such as 42 in each toner conveyor such as 40; connections to the diverter electrodes are depicted schematically. Preferably, the diverter control voltage should have an effect only at the diverter electrode, and signal transitions occurring on the trace between chip 73 and diverter electrode 42 should not affect toner particles moving nearby on the conveyors. Accordingly, these control voltages are physically routed underneath the barrier voltage electrodes 45; and their effect on toner particles is thereby screened by the DC voltage (BV in FIG. 4) carried on the barrier electrodes. Each integrated circuit 73 preferably provides a large number of diverter control signals, 1024 in the preferred embodiment. In a 48-inch print width there are 115,200 pixel sites that are simultaneously printed in the preferred embodiment. Correspondingly, there are 115,200 toner conveyors, with each conveyor imaging toner destined for a single pixel site. Thus, 113 copies of integrated circuit chip 73 are provided on writing head 17 in the preferred embodiment. Each chip is preferably around 18 mm square, and employs an area array of flip chip connectors for attaching to matching traces on glass substrate 50 of FIG. 3 using the chip-on-board (COB) method of chip assembly. The chips 73 are preferably arranged in two rows across writing head 17. The incorporation of chips 71 and 73 on writing head 17 provides a method for implementing the large number of control signals required for the preferred parallel operation, at a reasonable manufacturing cost.

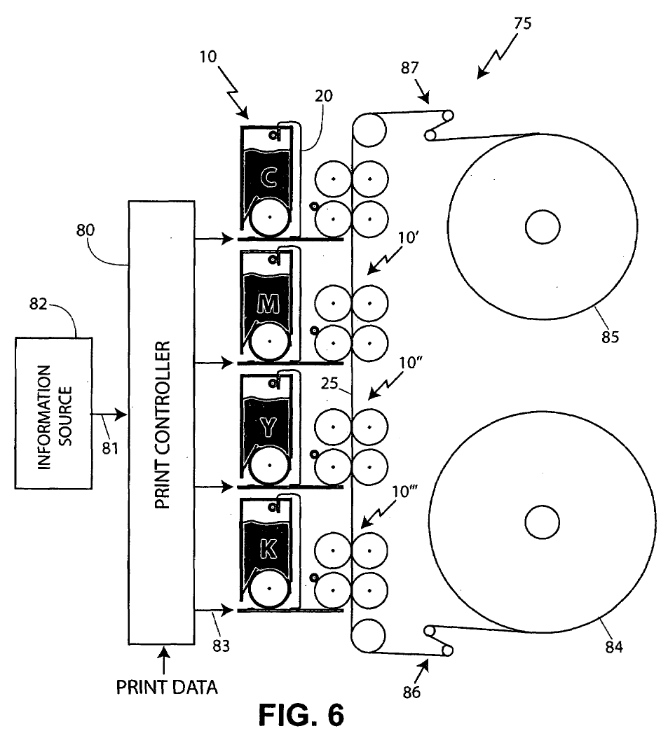

FIG. 6 depicts a full-color printing system or electronic printing press 75 of the current invention. The preferred embodiment includes four print engines 10, 10′, 10″, and 10′″ labeled C, M, Y, K, corresponding to the set of four preferred primary colors. A print controller 80 accepts print data 81 from an information source 82 and provides control information 83 to each of the print engines 10. Control information 83 includes control inputs 72 and 74 to IC chips 71 and 73 respectively, of FIG. 5. Return conveyor 20 of FIG. 1 is shown. The print engines are arranged in series about the print substrate 25 of FIG. 1. Print substrate 25 is a continuous web of paper in the preferred embodiment, fed from a source roll 84 and taken up by a destination roll 85. Instead of the paper being rolled up on destination roll 85, it may be processed directly with finishing equipment that can perform the required operations to generate separately printed pages or booklets, for example. Such operations may include slitting, duplexing, binding, etc. Tensioners 86 and 87 are provided for easing the transport of print medium 25.

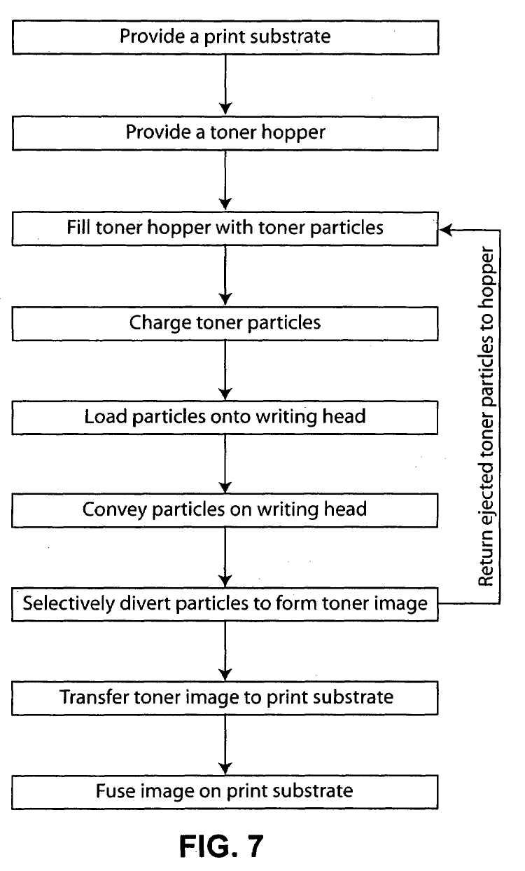

FIG. 7 is a flow chart illustrating a preferred version of the printing process, summarizing process steps described herein.

The advantages of the preferred embodiment of the current invention relate primarily to print speed, print resolution, cost of manufacture of the print system, and short run economy for variable printing as measured by the cost per page. As described, the preferred resolution is 2,400 DPI, and this is achieved by individually controlling each toner particle. Other electronic printers have not achieved to date this fine control over individual toner particles. While delivering this fine-grained image quality, the preferred speed of the 48-inch wide preferred print substrate is 200 feet per minute, at the upper end of speeds available from printing presses of all types. This high performance is achievable because a modern printer controller augmented by IC chips on the writing head is fast enough to process the print data and distribute the required control signals, and because the imaging process is highly parallel. The parallel process of the current invention contrasts with electrophotography (Xerography) wherein a scanning laser is used to sequentially form the image. At the preferred resolution and speed, there are 115,200 independent single-particle-print-engines (micro print engines), each contributing an imaging event every 10 microseconds. Each micro-print engine includes a toner conveyor equipped with a diverter electrode and a transfer electrode. The imaging power of the print system described sums to over 10 billion (1.15×10¹⁰) individual toner particles imaged per second. Moreover, every page can portray different print data (variable printing), resulting in an economical run length of just a few pages. Another cost factor for electrophotographic printing surrounds the use of photoconductive drums; these have a maintenance life of a few thousand pages. This cost is eliminated using the solid state printing process of the current invention, wherein the print algorithm is implemented using an array of special purpose IC chips mounted on the writing head, supported by a fast general-purpose computer implementing the print controller. Many of the mechanical components of existing high-end print systems are replaced by electronic equivalents, and this can lead to highly reliable operation and low maintenance costs. The size, mass, and footprint of the preferred embodiment are each at least an order of magnitude less than their counterparts observed in printing presses operating today.

I claim:

1. A printing method for use with a print substrate and a toner hopper containing toner particles comprising the steps of:
charging the toner particles;
loading the charged toner particles onto a writing head;
providing on said writing head toner conveyors that are one toner particle wide; transporting the charged particles on the toner conveyors;
selectively ejecting certain charged particles being transported on each toner conveyor to form a toner image from the remaining charged particles transported on the toner conveyor; and,
transferring the toner image formed by each toner conveyor to a corresponding pixel site on the print substrate.

2. The printing method of claim 1 including the step of fusing the transferred toner image on the print substrate.

3. The printing method of claim 1 including the step of providing barrier electrodes at the longitudinal edges of each toner conveyor for containing the charged toner particles being transported.

4. The printing method of claim 1 including the step of feeding the print substrate as a continuous web during the transferring step.

5. The printing method of claim 1, including the step of returning the ejected particles to the toner hopper.

6. The printing method of claim 1 wherein the writing head includes a glass substrate.

7. The printing method of claim 1 wherein the conveying step includes providing voltage traveling waves.

8. The printing method of claim 1 wherein the step of selectively ejecting certain charged particles includes activating a diverter electrode in each of the toner conveyors to selectively eject the certain charged particles in accordance with the toner image.

9. The printing method of claim 3 wherein the barrier electrodes are spaced apart sufficiently to enable transport of a plurality of particles on each conveyor electrode of each toner conveyor.

10. The printing method of claim 8 wherein the step of activating a diverter electrode in each of the toner conveyors is controlled by a print controller that receives print data from an information source and generates control signals to integrated circuit chips mounted on the writing head, and the integrated circuit chips provide a control signal to each of the diverter electrodes.

11. A print system for use with a print substrate and toner particles comprising:
a toner hopper adapted for containing the toner particles;
a toner charging device for charging the toner particles;
a writing head for receiving the charged toner particles from the toner charging device and transporting the charged toner particles on toner conveyors;
barrier electrodes defining the width of each toner conveyor wherein the barrier electrodes are spaced apart by approximately one toner diameter;
a diverter electrode in each toner conveyor for selectively ejecting certain charged toner particles from the toner conveyor to form a toner image from the charged toner particles remaining on the toner conveyor;
a return conveyor for returning the ejected toner particles to the toner hopper; a transfer roll or belt for transferring the toner image to the print substrate; and, a controller that accepts print data delivered to the print system and controls the diverters in accordance with the toner image.

12. The print system of claim 11 including a fuser for fusing the transferred toner image on the print substrate.

13. The print system of claim 11 wherein the controller includes integrated circuit chips mounted on the writing head.

14. The print system of claim 11 wherein the toner conveyors employ voltage traveling waves.

15. The print system of claim 11 wherein the width of the toner conveyors and the width of the diverter electrodes is approximately one toner particle wide.

16. The print system of claim 11 wherein the width of the toner conveyors and the width of the diverter electrodes is several toner particles wide.

17. The print system of claim 11 wherein the writing head includes a glass substrate.

18. The print system of claim 11 wherein the writing head has a width of 8-50 inches.

19. The print system of claim 11 wherein the toner image has a resolution of 300-2,500 dots per inch.

20. The print system of claim 11 wherein at least eighty percent of the toner particles have a diameter within twenty percent of the mean toner particle diameter.

21. A print system comprising a plurality of print engines arranged serially about a print substrate, each engine corresponding to a primary color to be printed, wherein each print engine comprises:
a section of the print substrate;
a toner hopper;
toner particles having a primary color in said hopper;
a toner charging device for charging the toner particles;
a writing head for accepting the charged toner particles and transporting them on toner conveyors;
diverter electrodes in each of the toner conveyors for selectively ejecting certain ones of the charged toner particles to form a toner image from the remaining charged toner particles; a return toner conveyor for returning the ejected toner particles to the toner hopper; a transfer roll or belt for transferring the toner image from the conveyors on the writing head to the print substrate; and,
a controller that accepts print data delivered to the print system and controls the diverters in accordance with the toner image.

22. The print system of claim 21 including one or more fusers for fusing on the print substrate images transferred from the print engines in said serial arrangement.

23. A method for providing matched tribo-electric properties within a printing system using toner particles and control surfaces comprising the step of:
forming on the control surfaces a coating derived from the constituent materials of the toner particles, or derived from material equivalents of the constituent materials having similar triboelectric properties.
